(19) United States
(12) Patent Application Publication
(10) Pub. No.: US 2002/0060814 A1
(43) Pub. Date: May 23, 2002

(54) Device for extracting processing residues

(75) Inventors: Rolf Angelbeck, Kiel (DE); Siegfried Beisswenger, Preetz (DE)

Correspondence Address: SCHIFF HARDIN & WAITE, 6600 SEARS TOWER, 233 S WACKER DR, CHICAGO, IL, 60606-6473, US

(73) Assignee: Heidelberger Druckmaschinen AG

(21) Appl. No.: 10/007,035

(22) Filed: Nov. 8, 2001

(30) Foreign Application Priority Data
Nov. 21, 2000 (DE) 100 57 688.5

(51) Int. Cl. B41C 1/02

(52) U.S. Cl. 358/3.32

(57) ABSTRACT

In a device for extracting processing residues for a processing apparatus having a plurality of processing units preferably movable along a processing path, particularly for an engraving machine having a plurality of engraving supports, an admission opening of an extraction conduit is allocated to each processing unit. The device has a collecting main for the extraction. For this purpose, the collecting main is preferably designed as an extraction channel, and the end of each of the extraction conduits facing away from the processing unit comprises a mouthpiece that discharges into the extraction channel, namely preferably into an admission slot of the extraction channel, whereby it is movable along and in the admission slot.

### BACKGROUND OF THE INVENTION

The invention is directed to a device and method for extracting processing residues for a processing apparatus having a plurality or processing units that are preferably movable along a processing path, particularly for an engraving machine having a plurality of engraving supports, whereby an admission opening of an extraction conduit is allocated to each processing unit.

Given a processing apparatus of the above type, particularly given engraving machines for example, for engraving printing form cylinders for rotogravure, it is standard to connect each processing unit to a type of vacuum cleaner via an extraction conduit, normally an extraction hose, in order to extract processing residues, for example dust or gasses, from the work region. It is space-wasting and involved to conduct these extraction conduits in cable chains or the like, particularly when the processing units are movable along a processing path. Moreover, such long extraction conduits are then needed that only about half of the cleaning power of the vacuum cleaner may take effect at the extraction side of the extraction conduits under certain circumstances.

### SUMMARY OF THE INVENTION

It is an object of the invention to improve a device of the type initially cited, particularly designing it to be more economical and stringent.

According to the present invention, a collecting main for the extraction is provided.

A collecting main is provided so that the air management can advantageously occur in bundled or concentrated fashion and, for example, can also be arranged centrally and in space-saving fashion or space-beneficially. As a result thereof, moreover, a maximum cleaning power can also be utilized since the collecting main can comprise a liberally dimensioned cross-section that can be connected to a vacuum cleaner, so that a correspondingly good flow is assured.

A next development of the invention provides that the collecting main is designed as an extraction channel, and that end of each of the extraction conduits facing away from the processing unit comprises a mouthpiece or snout that discharges into the extraction channel.

Such an extraction channel can be centrally and space-beneficially arranged and lay, and accesses thereto in the form of the mouthpieces or snouts can also be arranged positionally suited for the extraction conduits. A new, additional connection or a replacement of parts is also advantageously possible given the arrangement of the invention.

Moreover, the mouthpieces can be moved along the extraction channel. The mouthpieces can then replicate a movement of the processing units, particularly of engraving supports of an engraving machine, so that connecting extraction hoses between a mouthpiece and a processing unit need not be readjusted onto curved paths but can form an essentially straight line, direct and relatively short connection, which is beneficial for the design of the device and its effective cleaning power.

For that purpose, for example, each mouthpiece can discharge into an admission slot or gap of the extraction channel and be movable along this admission slot.

Elastic seal lips, as provided in a preferred embodiment of the invention, can close the admission slot, so that, despite said mobility, the admission slot is essentially always closed over its length in order to avoid bleed air. Only the mouthpieces then respectively project between the seal lips for opening the seal lips. This opening region of the seal lips at the mouthpieces migrates with the mouthpieces given movement of the latter. The seal lips remain closed preceding the respective mouthpiece in moving direction, and, due to their elasticity, the seal lips in turn close automatically behind the mouthpiece. The closing of the seal lips can be supported by a closure element that leads and/or trails the respective mouthpiece. Roller elements that roll along the seal lips can be provided therefore.

The spreading and opening of the seal lips given a movement of the mouthpiece can be promoted by the shaping of the mouthpiece in that, for example, the mouthpiece comprises spurs that point in the possible motion direction. Such a spur can, in particular, be essentially wedge-shaped, so that the cross-section of the mouthpiece is shaped roughly like, for example, a small boat.

In a further development of the invention that the processing units are movable along a carrier, and that the collecting main is arranged at or in this carrier, as well as centrally, protected, and close to the moving processing units, designed, for example, as an extraction channel integrated in a hollow carrier profile.

### BRIEF DESCRIPTION OF THE DRAWINGS

FIG. 1 is a cross-section of an equipped engraving machine according to the invention for engraving rotogravure form cylinders;

FIG. 2 is a plan view onto the engraving machine of FIG. 1;

FIG. 3 is a magnified detail from the cross-section of FIG. 1;

FIG. 4 is a cross-section of a mouthpiece entering between seal lips, shown from above;

FIG. 5 is a section of the mouthpiece and its surroundings according to FIG. 4, shown in a side view; and

FIG. 6 shows the section of the mouthpiece according to FIG. 5 in end view.

### DESCRIPTION OF THE PREFERRED EMBODIMENTS

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

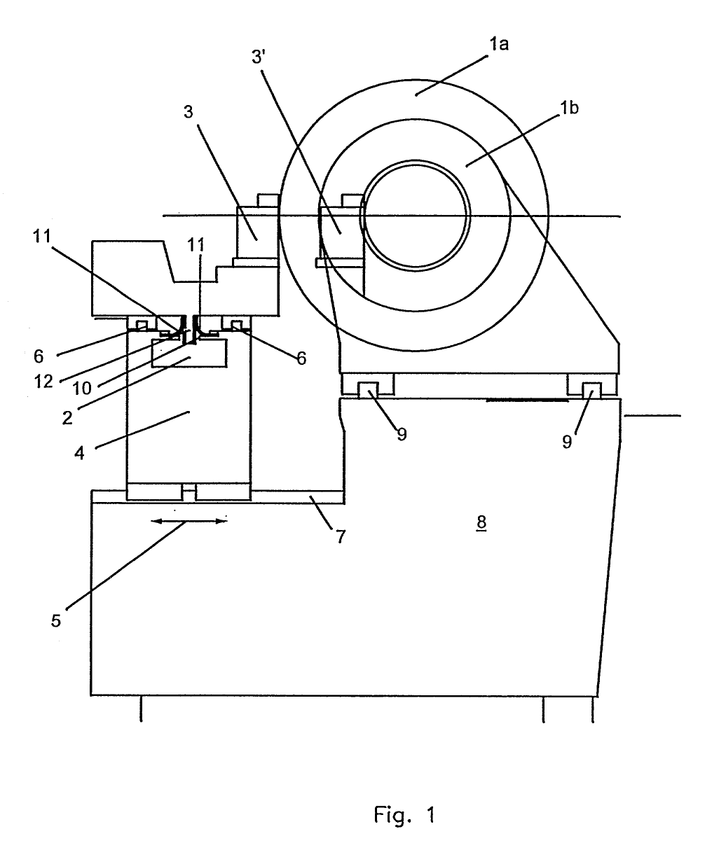

FIG. 1 shows a cross-section of an engraving machine for engraving rotogravure form cylinders 1a, 1b that is equipped according to the invention with a central extraction channel 2 parallel to the printing form cylinders.

The engraving machine comprises engraving supports 3, 3′ (only schematically indicated) that are displaceable into the plane of the drawing and out of the plane of the drawing along the printing form cylinders 1a, 1b on rails 6 on a carrier 4 in which the extraction channel 2 is integrated and that can be positioned at the printing form cylinders 1a, 1b in the direction of a double arrow 5, being positioned together with the carrier on rails 7. Printing form cylinders 1a, 1b that are possible as an alternative and have exemplary, different diameters are shown, as are two corresponding positions 3, 3′ of the engraving supports.

The carrier 4 and the printing form cylinders 1a, 1b are seated on a machine undercarriage 8, whereby the printing form cylinders 1a, 1b are also arranged displaceable on rails 9 in their axial direction.

It can also be derived from FIG. 1 that the upper side of the extraction channel comprises an admission slot 10 that precedes over its length and that is closed with seal lips 11 between which mouthpieces penetrate and project into the extraction channel.

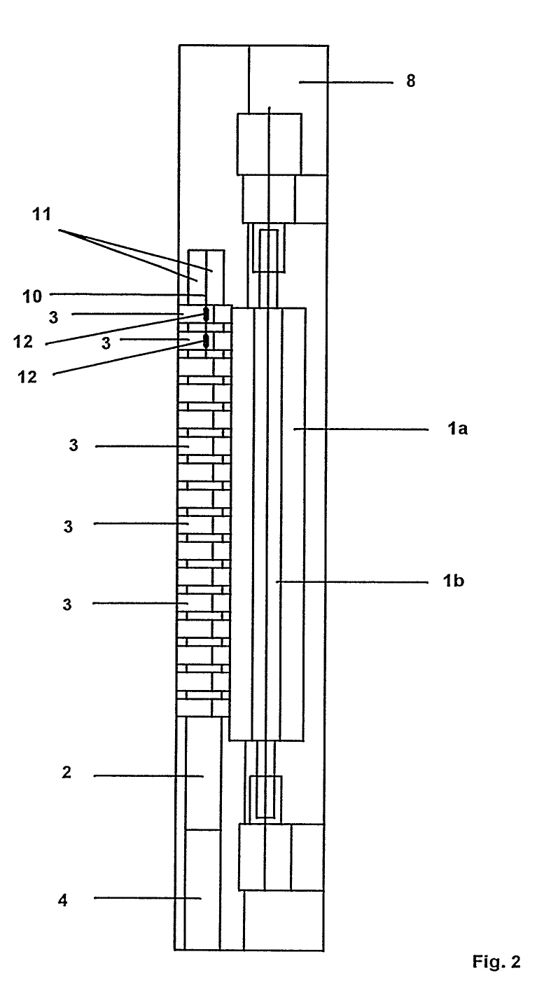

FIG. 2 shows a plan view onto the engraving machine of FIG. 1 in a form that is more simplified and schematic for the sake of clarity. Identical components in FIG. 2 are referenced with the same reference characters as in FIG. 1.

Proceeding beyond FIG. 1, FIG. 2 indicates mouthpieces 12, particularly at two of the engraving supports 3 arranged along the printing form cylinder 1a, 1b, that project between the seal lips 11 into the admission slot 10 of the extraction channel and thereby spread the seal lips 11 apart. As the engraving supports move on the carrier 4 along the printing form cylinder 1a or 1b, the mouthpieces 12 shift in the admission slot 10 in the same longitudinal direction.

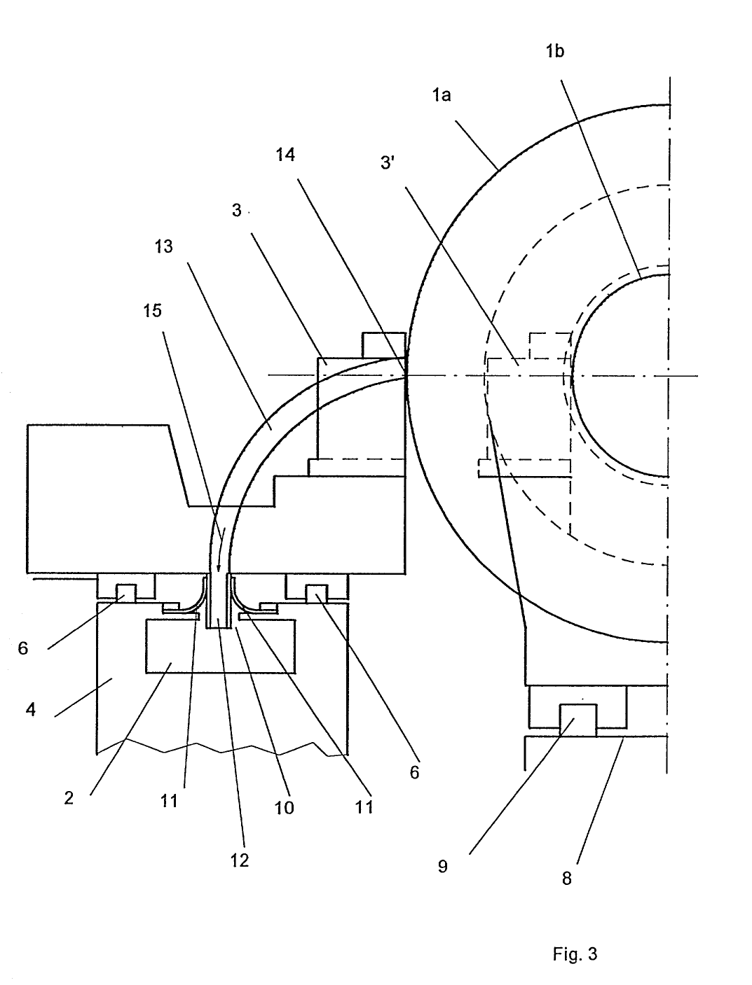

FIG. 3 shows a magnified detail from FIG. 1 wherein the same components are again referenced with the same reference numerals as in the preceding Figures.

In particular, the region of a mouthpiece 12 projecting into the extraction channel 2 can be seen in greater detail and more exactly in FIG. 3. A connecting hose 13 between an engraving support 3 and the mouthpiece 12 is indicated, again only schematically and fundamentally. The connecting hose 13 has its admission opening 14 in the region of the engraving support in the proximity of the region of the printing form cylinder 1a or 1b to be processed, and from which it extracts residues of any and all types that arise during engraving, i.e. particularly dust and gasses, in the direction of the arrow 15 through the mouthpiece 12 into the central extraction channel, which is uniformly accessible to all engraving supports via relatively short and direct connecting hoses 13. The extraction channel 2 itself can have one of its end faces connected to a hose with a relatively large cross-section that leads to a blower device or the like.

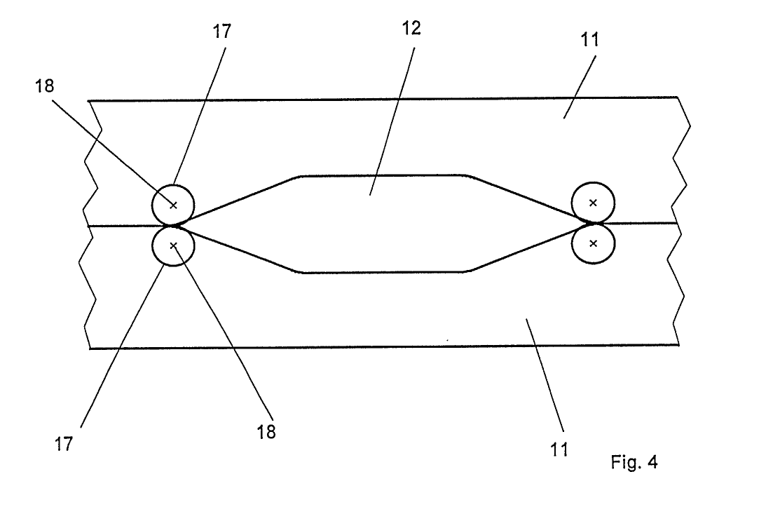

First in cross-section, then in a side view, and then in an end view, FIGS. 4 through 6 show a region of a mouthpiece 12 in its surroundings and in a view that is magnified further compared to the illustration of FIG. 3.

FIG. 4 shows how the seal lips 11 close the admission slot 10 of the extraction channel 2 situated therebelow but are spread apart by the mouthpiece 12. For improving the spreading event, the mouthpiece is designed roughly boat-shaped in cross-section with essentially wedge-shaped spurs 16. Moreover, roller elements 17 with the axis lines 18 are indicated that serve as closure elements for holding or pressing the seal lips 11 together in front of and behind the mouthpiece 12.

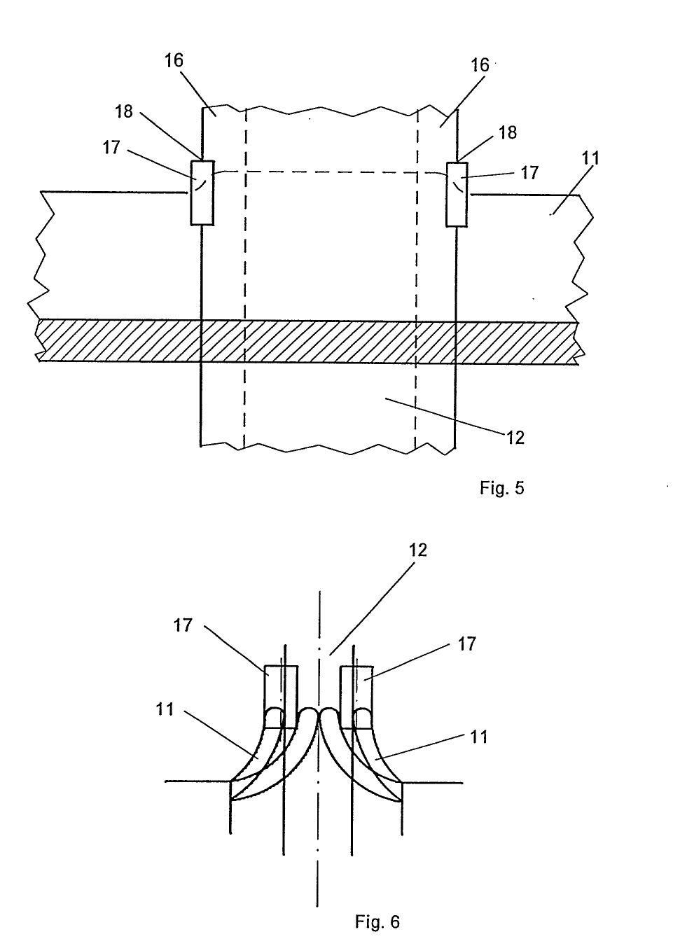

The arching of the seal lips 11 when they are spread apart and the closure function of the roller elements 17 can be clearly seen in FIG. 5.

The closure function of the roller elements 17 can be seen even more clearly in the end view of FIG. 6.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

We claim as our invention:

1. A device for extracting processing residues for a processing apparatus having a plurality of processing units as engraving supports movable along a processing path in an engraving machine, comprising:
an admission opening of an extraction conduit allocated to each processing unit; and
a collecting main for the extraction conduit.

2. The device according to claim 1 wherein the collecting main comprises an extraction channel and each of the extraction conduits comprises a mouthpiece at its end facing away from the processing unit, said mouthpiece discharging into the extraction channel.

3. The device according to claim 2 wherein the mouthpiece discharges into an admission slot of the extraction channel and is movable along the admission slot.

4. The device according to claim 3 wherein the admission slot is covered with elastic seal lips between which the mouthpiece projects.

5. The device according to claim 4 wherein the mouthpiece comprises spurs in a direction of an extent of the admission slot for spreading the seal lips.

6. The device according to claim 4 wherein at least one closure element leads and trails the mouthpiece for a closure of the seal lips outside a region of the mouthpiece.

7. The device according to claim 6 wherein the closure element comprises roller elements rolling along the seal lips.

8. The device according to claim 1 wherein the processing units are movable along a carrier, and the collecting main is arranged at said carrier.

9. A device for extracting processing revenues when engraving an engraving cylinder of an engraving machine by use of at least one engraving support having an engraving element which is movable in parallel with a rotating axis of the engraving cylinder, comprising:
a collecting main running parallel to the rotating axis of the engraving cylinder and providing a suction air passageway;
flexible sealing members adjacent an admission slot into the collecting main;
a mouthpiece movable along between the sealing members; and
a connecting hose between the mouthpiece and a region adjacent the cylinder with which the processing residues are extracted by suction through the connecting hose.

10. A method for extracting processing residues in an engraving machine having at least one engraving support with an engraving element for engraving an engraving cylinder and wherein the engraving support is movable in parallel to a rotating axis of the engraving cylinder, comprising the steps of:
providing a suction collecting main running parallel to the engraving cylinder rotating axis;
providing a connecting hose having one end adjacent where the engraving support and engraving element are processing the engraving cylinder for removal of the processing residues by suction, and an opposite end of the hose between sealing members extending into the collecting main; and
as the engraving element moves along parallel to the rotating axis of the engraving cylinder moving the mouthpiece of the connecting hose along the collecting main.

11. The method according to claim 10 including the step of providing longitudinally extending flexible sealing lips on opposite sides of an admission slot of the collecting main and sliding the mouthpiece along between the sealing lips as the engraving support moves parallel to the rotating axis of the engraving cylinder.
